(19) United States
(12) Patent Application Publication
(10) Pub. No.: US 2025/0314344 A1
(43) Pub. Date: Oct. 9, 2025

(54) STAND FOR HOLDING LARGE DISPLAYS

(71) Applicant: SEONGIL PARK, Goyang-si (KR)

(72) Inventor: SEONGIL PARK, Goyang-si (KR)

(21) Appl. No.: 19/072,326

(22) Filed: Mar. 6, 2025

(30) Foreign Application Priority Data
Apr. 5, 2024 (KR) 10-2024-0046473

(51) Int. Cl. F16M 11/10; F16M 11/22

(52) U.S. Cl. CPC F16M 11/10; F16M 11/22

(57) ABSTRACT

A stand for holding large displays may include a base plate of a predetermined size seated on a floor, a post of a predetermined length having a lower end assembled to the base plate and installed vertically or inclined at a predetermined angle so that an upper end has a predetermined height, a horizontal frame installed at the upper end of the post and horizontally installed so that both ends have a predetermined length on both sides of the post, a pair of display mounts assembled to a back side of a display and having a predetermined length in upward and downward directions based on the display, and a pair of connection frames configured to detachably connect the horizontal frame and the pair of display mounts and selectively adjustable in their angle to adjust the angle of the pair of display mounts.

### CROSS-REFERENCE TO RELATED APPLICATION

This application claims priority to Korean Patent Applications No. 10-2024-0046473, filed in the Korean Intellectual Property Office on Apr. 5, 2024, the entire contents of which are hereby incorporated by reference.

### BACKGROUND

### Technical Field

The present disclosure relates to a stand for holding large displays, and more specifically, to a stand for holding large displays, which supports large-screen monitors, TVs, and the like (hereinafter referred to as ‘displays’), allowing for adjustments in height and angle.

### Description of Related Art

In recent years, displays of various sizes such as LCDs, PDPs, LEDs, and OLEDs are manufactured in various ways, and various types of stands, which are capable of stably mounting these displays while allowing easy adjustments in height, angle, and the like as needed, are developed.

An example of the related technology for the purposes discussed above can be found in Korean Patent Laid-Open Publication No. 2020-0088043 (hereinafter referred to as ‘patent literature’) which discloses a stand and a display device including the same.

The patent literature proposes a configuration including a base assembly including a first base and a second base coupled to the first base, a support bar extending in a height direction of the stand and coupled to the base assembly, a first vibration attenuation unit installed on the first base, the first vibration attenuation unit including a movable member exposed to the outside of the first base and configured to move in a height direction of the stand, and a second vibration attenuation unit installed on the second base, the second vibration attenuation unit including a rotating member exposed to the outside of the second base, and configured to move in the height direction of the stand and rotatable to impart mobility to the stand.

However, the patent literature has a problem. That is, it is difficult to adjust the height and angle of the installed display as needed. In addition, with advancements in display manufacturing technology, thin and light-weight large displays are developed and used for various purposes such as business PCs, home PCs, TVs, and advertising displays, but the stand of the patent literature cannot be adjusted to meet the VESA mount standard of the display, limiting the range of displays that can be installed.

Therefore, it is necessary to develop a stand for holding large displays with an improved structure that allows for width adjustments to accommodate various VESA mount standards for the installations of the large displays, and that also enables adjustments of installation height and angle as needed.

### SUMMARY

The present disclosure has been devised to solve the problems of the related display mounting stand discussed above, and an object of the present disclosure is to provide a stand for holding large displays that allows for width adjustments to accommodate various VESA mount standards for the installations of the large displays, and that also enables adjustments of installation height and angle as needed.

According to some aspects, a stand for holding large displays is provided, which may include a base plate of a predetermined size seated on a floor, a post of a predetermined length having a lower end assembled to the base plate and installed vertically or inclined at a predetermined angle so that an upper end has a predetermined height, a horizontal frame 30 installed at the upper end of the post and horizontally installed so that both ends have a predetermined length on both sides of the post, a pair of display mounts assembled to a back side of a display and having a predetermined length in upward and downward directions based on the display, and a pair of connection frames configured to detachably connect the horizontal frame and the pair of display mounts and selectively adjustable in their angle to adjust the angle of the pair of display mounts, in which the pair of connection frames include a frame fixing unit installed on the horizontal frame, an angle adjusting unit installed on the frame fixing unit in an angle-adjustable manner, and a mount fixing unit installed on the pair of display mounts and detachably assembled to the angle adjusting unit.

According to some aspects, the horizontal frame may include a horizontal portion of a predetermined length covering an upper surface of the post, and a vertical portion of a predetermined length installed such that one end is connected to the horizontal portion and the other end has a predetermined width and length along an upper side of one side of the post, and the vertical portion may include a plurality of installation holes in which the frame fixing unit is installed, and the plurality of installation holes are disposed at predetermined intervals in a plurality of rows along a length of the vertical portion.

In addition, a plurality of wheels may be movably installed on a lower surface of the base plate.

In addition, the display mount may include a frame portion with a C-shaped cross-section and also a length in a vertical direction, first mounting holes formed at predetermined intervals along a length on both sides of the frame portion that are opposite to each other, and a plurality of second mounting holes formed at predetermined intervals along a length of one side of the frame portion that is opposite to the back side of the display, in which the mount fixing unit may be installed through the first mounting holes, and the display mount may be engaged and fixed to the back side of the display by a screw through the second mounting holes.

According to some aspects, there is an advantage that it is possible to install, on the stand, various VESA-standard displays including large displays by assembling the display mount assembled with the mount fixing unit onto the back side of the display, and then fitting the mount fixing units into the angle adjusting units of the connection brackets assembled with the horizontal frame in accordance with the width of the display mount.

In addition, since the installation angle of the display mount can be adjusted using the angle adjusting units of the connection brackets, it is possible to adjust the installation angle of the display as needed.

In addition, since a plurality of first and second mounting holes are formed at predetermined intervals along the length of the display mount, it is possible to properly adjust the position to be coupled to the VESA hole on the back side of the display, thereby adjusting the installation height of the display.

### BRIEF DESCRIPTION OF THE DRAWINGS

The above and other objects, features and advantages of the present disclosure will become more apparent to those of ordinary skill in the art by describing in detail exemplary aspects thereof with reference to the accompanying drawings, in which:

FIG. 1 is a perspective view illustrating an example of a stand for holding large displays according to some aspects;

FIG. 2 is a side view illustrating an example of a stand for holding large displays according to some aspects;

FIG. 3 is an exploded perspective view illustrating an example of a base plate and a post according to some aspects;

FIG. 4 is a diagram illustrating a lower surface of the base plate according to some aspects;

FIG. 5 is a perspective view illustrating an example of a horizontal frame according to some aspects;

FIG. 6 is a perspective view illustrating an example of a display mount and a connection bracket assembled on the horizontal frame according to some aspects;

FIG. 7 is a perspective view of the connection bracket in a separated state according to some aspects;

FIG. 8 is a perspective view of a frame fixing unit and an angle adjusting unit separated from each other according to some aspects;

FIG. 9 is a perspective view of the display mount and a mount fixing unit separated from each other according to some aspects;

FIG. 10 is a diagram illustrating an example in which a position of the display mount is adjusted based on the horizontal frame according to some aspects; and

FIG. 11 is a diagram illustrating an example in which an angle of the connection bracket is adjusted, resulting in an angle of the display mount being adjusted according to some aspects.

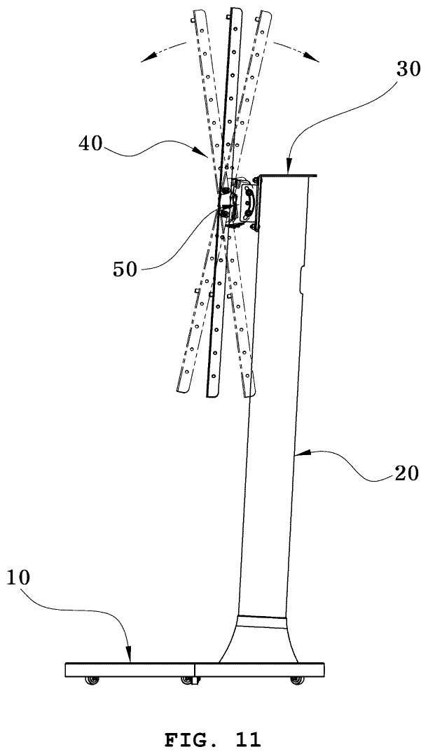

### DETAILED DESCRIPTION

Hereinafter, certain aspects of the present disclosure will be described in detail with reference to the accompanying drawings.

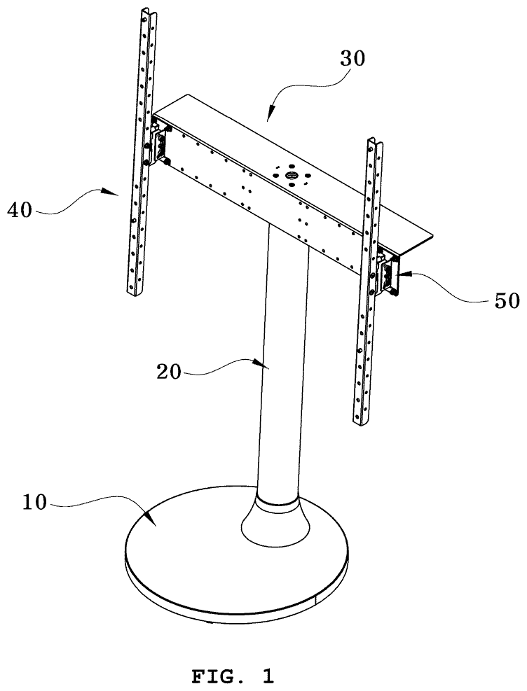

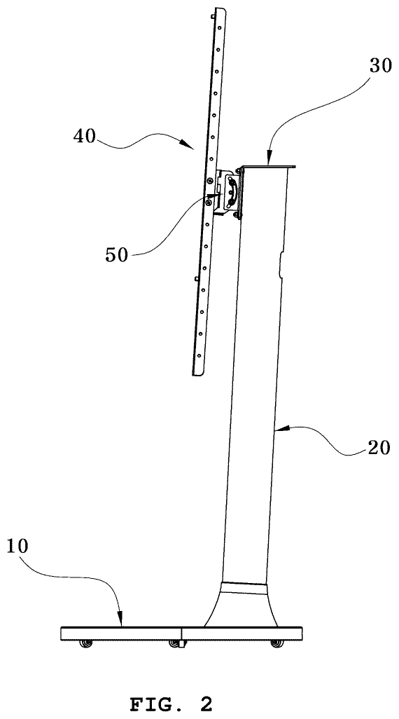

The present disclosure proposes a stand for holding large displays that allows for width adjustments to accommodate various VESA mount standards for the installations of the large displays, and also enables adjustments of installation height and angle as needed. According to some aspects, the stand for holding large displays may include a base plate 10, a post 20, a horizontal frame 30, a display mount 40, and a connection bracket 50, as illustrated in FIGS. 1 and 2.

The base plate 10 may be configured such that the post 20, which will be described below, is installed thereon at right angles or at a predetermined inclination angle to support a display installed on the display mount 40, which will be described below, from being slanted or collapsed.

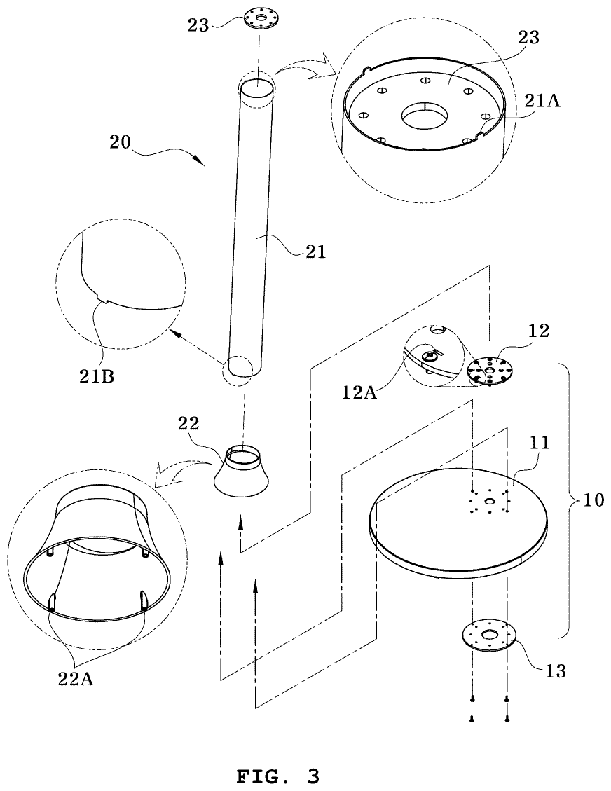

The base plate 10 may include a disk-shaped bottom plate 11 of a predetermined diameter, an upper reinforcing plate 12 of a predetermined size installed on an upper surface of the bottom plate 11, and a lower reinforcing plate 13 of a predetermined size installed on a lower surface of the bottom plate 11, as illustrated in FIG. 3.

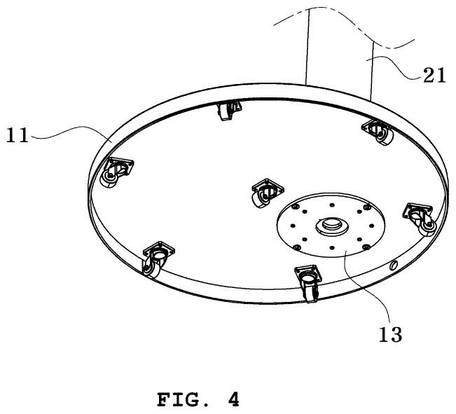

In addition, a plurality of wheels may be installed radially on the lower surface of the bottom plate 11, as illustrated in FIG. 4, and through these wheels, an installation position of the base plate 10 may be easily moved.

In addition, the upper reinforcing plate 12 may be provided with a plurality of screws to pass through the bottom plate 11 and screw into the lower reinforcing plate 13, which allows the upper reinforcing plate 12, the bottom plate 11, and the lower reinforcing plate 13 to be firmly fixed to each other. At this time, the upper reinforcing plate 12 may be inserted into a lower portion of a post body 21, which will be described below, and integrally fixed through welding.

Additionally, a plurality of screws may be assembled with the lower reinforcing plate 13 and passed through the bottom plate 11 and the upper reinforcing plate 12, protruding upward by a predetermined length, and through the plurality of screws, a lower cover 22 of the post 20, which will be described below, is fixed to the upper surface of the bottom plate 11.

In addition, instead of being assembled with the lower surface of the bottom plate 11 through a fastening member, the lower reinforcing plate 13 may be firmly and integrally fixed with the lower surface of the bottom plate 11 by welding.

At this time, insertion holes 12A of a predetermined size may be formed in the upper reinforcing plate 12 at predetermined intervals, and lower fixing protrusions 21B of the post body 21, which will be described below, may be inserted into these insertion holes 12A such that the post 20 is fixed in position and does not rotate arbitrarily.

With the configuration of the base plate 10 as described above, the part assembled with the post 20 is firmly supported through the upper and lower reinforcing plates 12 and 13 such that deformation that may occur when mounting the display, which could otherwise happen due to the display's own weight, is reliably prevented.

The post 20 is configured to be installed with the horizontal frame 30, which will be described below, while supporting the same at a predetermined height from the floor.

As illustrated in FIG. 3, this post 20 includes the post body 21 having a shape of a hollow circular tube of a predetermined diameter, the lower cover 22 which is fixed to the base plate 10 and into which a lower end of the post body 21 is inserted by a predetermined depth, and a disk-shaped fixing plate 23 that is integrally fixed to an upper inner side of the post body 21 and that is screw-engaged with the horizontal frame 30 to be described below.

Furthermore, a plurality of upper fixing protrusions 21A and a plurality of lower fixing protrusions 21B are formed at predetermined intervals on upper and lower ends of the post body 21, and installed such that the lower fixing protrusions 21B are inserted into the insertion holes 12A formed in the upper reinforcing plate 12 of the base plate 10 and the upper fixing protrusions 21A are inserted into insertion holes 31A of the horizontal frame 30, thereby firmly maintaining the position where the base plate 10, the post 20, and the horizontal frame 30 are combined with each other.

The horizontal frame 30 is installed at the upper end of the post 20 and attached with a frame fixing unit 51 of the connection bracket 50 to be described below.

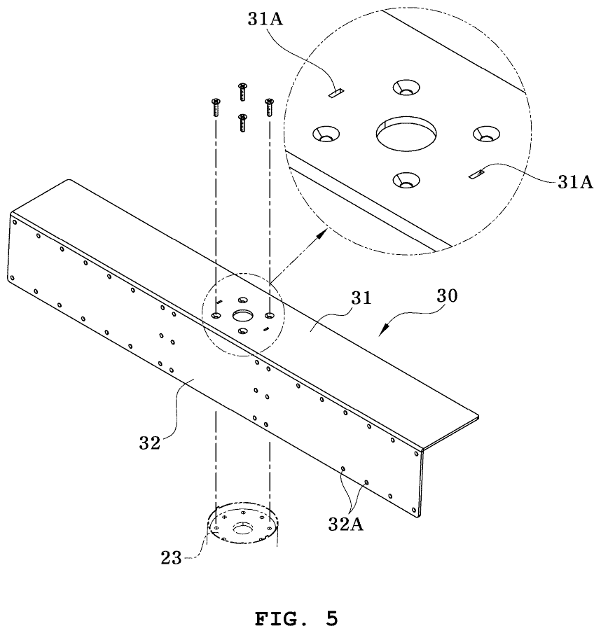

As illustrated in FIG. 5, the horizontal frame 30 is configured as a frame with an inverted L-shaped cross-section as a whole, which includes a horizontal portion 31 of a predetermined length covering an upper surface of the post 20, and a vertical portion 32 of a predetermined length installed such that one end is connected to the horizontal portion 31 and the other end has a predetermined width and a predetermined length along an upper side of one side of the post 20.

In addition, the horizontal portion 31 includes, formed in the middle portion thereof, a plurality of screw holes (no reference numerals shown) for screw engagement with the fixing plate 23 fixedly installed at the upper portion of the post body 21, and a plurality of insertion holes 31A into which the upper fixing protrusion 21A of the post body 21 is inserted by a predetermined depth.

In addition, the vertical portion 32 includes a plurality of installation holes 32A disposed at predetermined intervals in a plurality of rows along the length of vertical portion 32 to be engaged with the frame fixing unit 51, and through this, the installation position of the frame fixing unit 51 may be appropriately changed in accordance with the intervals of VESA holes formed on a back side of the display, thereby allowing for the installations of various VESA-standard displays.

The display mount 40 is configured such that it 40 is screw-engaged into the VESA holes formed in the back side of the display so that the display is fixedly supported on the horizontal frame 30 through the connection bracket 50 to be described below.

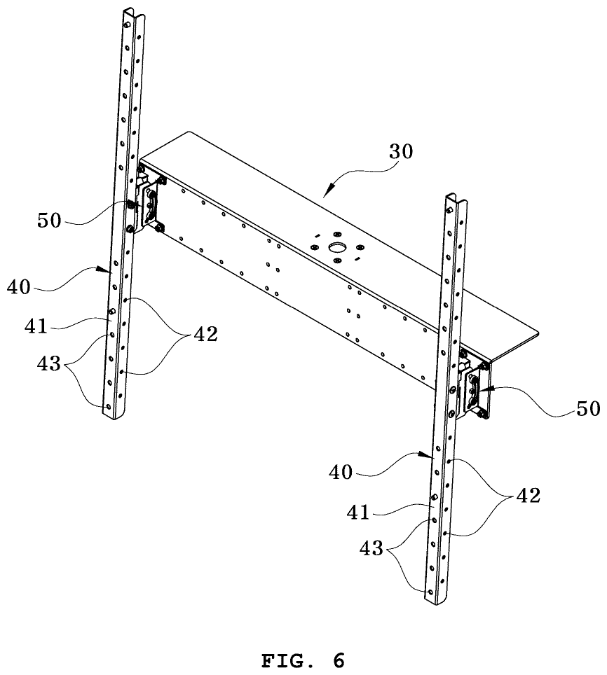

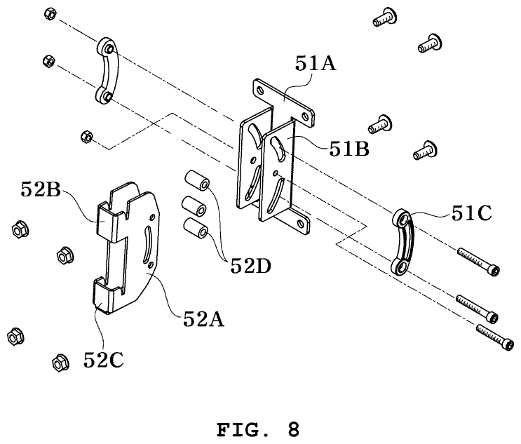

As illustrated in FIGS. 6 and 8, the display mount 40 includes a frame portion 41 having a C-shaped cross-section and having a length in a vertical direction, first mounting holes 42 formed at predetermined intervals along the length on both sides of the frame portion 41 that are opposite to each other, and a plurality of second mounting holes 43 formed at predetermined intervals along the length on one side of the frame portion 41 opposite to the back side of the display.

A pair of display mounts 40, corresponding to the positions of the VESA holes of the display, are screw-engaged and fixed vertically at predetermined intervals, and mount fixing units 53 of the connection brackets 50 are assembled to the display mounts 40 and fit into angle adjusting units 52 of the connection brackets 50 as necessary so that the display is fixedly installed on the stand or the display is separated from the stand.

In addition, by changing the position of the second mounting hole 43 into which the screw is engaged, the position of the display fixed to the display mounts 40 is properly adjusted, thereby adjusting the installation height of the display.

The connection brackets 50 are configured to detachably connect the horizontal frame 30 and the pair of display mounts 40 and are selectively adjustable in their angle to adjust the angle of the pair of display mounts 40.

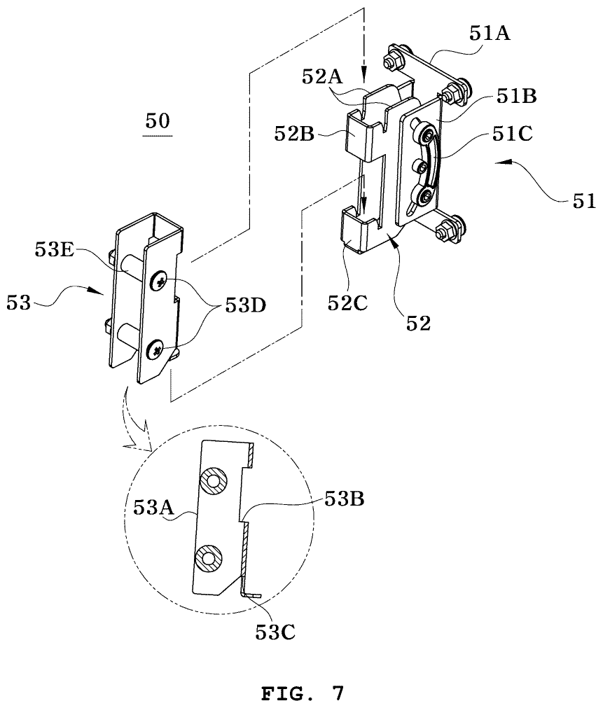

As illustrated in FIGS. 7 and 8, the connection bracket 50 includes the frame fixing unit 51 installed on the horizontal frame 30, the angle adjusting unit 52 installed on the frame fixing unit 51 in an angle-adjustable manner, and the mount fixing unit 53 installed on the pair of display mounts 40 and detachably assembled to the angle adjusting unit 52.

In addition, the frame fixing unit 51 includes a screw assembly plate 51A of a predetermined size that is screw-engaged with the vertical portion 32 of the horizontal frame 30, a pair of support plates 51B each having one end integrally connected to the screw assembly plate 51A and the other end protruding by a predetermined length, in which the other ends of the pair of support plates 51B are in parallel with each other, and coupling members 51C installed on the pair of support plates 51B to allow the angle adjusting unit 52 to adjust the angle within a predetermined angle range, and through this, the frame fixing unit 51 has a C-shaped cross-section that is open on the top, bottom, and one side.

In addition, arc-shaped guide holes (no reference numerals shown) are formed in the pair of support plates 51B, and the coupling members 51C may include a bolt (no reference numeral is shown) of a predetermined length, which is fastened through the guide holes and the angle adjusting unit 52.

In addition, the angle adjusting unit 52 includes a pair of insertion plates 52A formed at predetermined intervals and inserted into the space between the pair of support plates 51B, and upper and lower hook protrusions 52B and 52C formed protruding in an L-shape to be insertably fitted into the mount fixing unit 53 while connecting upper and lower portions of one end of the pair of insertion plates 52A, respectively.

In this case, a cylindrical sleeve 52D of a predetermined diameter is installed between the pair of insertion plates 52A so that the bolt of the coupling members 51C may also pass through the sleeve 52D placed in between, and through this, even when the nut is firmly tightened to the bolt, the gap between the pair of insertion plates 52A is maintained through the sleeve 52D and the shape thereof is not deformed.

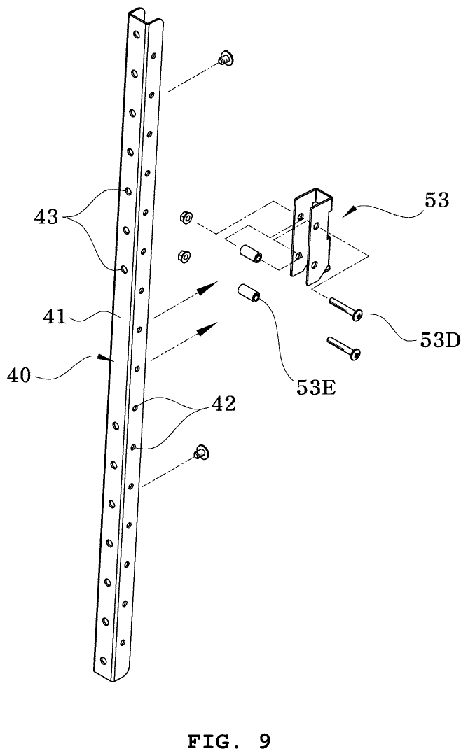

Meanwhile, as illustrated in FIGS. 7 and 9, the mount fixing unit 53 includes a fixing body 53A formed with a C-shaped cross-section, upper and lower locking parts 53B and 53C of a predetermined size, with which the upper and lower locking protrusions 52B and 52C of the angle adjusting unit 52 are securely locked as they are placed on one side of the fixing body 53A, and a plurality of fixing bolts 53D that are passed through both sides of the fixing body 53A and the first mounting hole 42 of the display mount 40 to fix the mount fixing unit 53 to the display mount 40.

In addition, inside the fixing body 53A, a plurality of sleeves 53E are installed in positions corresponding to positions through which the fixing bolts 53D are passed, and the plurality of sleeves 53E ensure that the fixing body 53A is firmly supported without being deformed in shape even when the nut is firmly tightened to the fixing bolts 53D.

As illustrated in FIG. 9, the mount fixing unit 53 may change position and thus be assembled with different ones of the first mounting holes 42 of the display mount 40, thereby adjusting the height at which the display mount 40 is supported by the horizontal frame 30 through the connection bracket 50, and as a result, the height at which the display is mounted on the display mount 40 is adjusted.

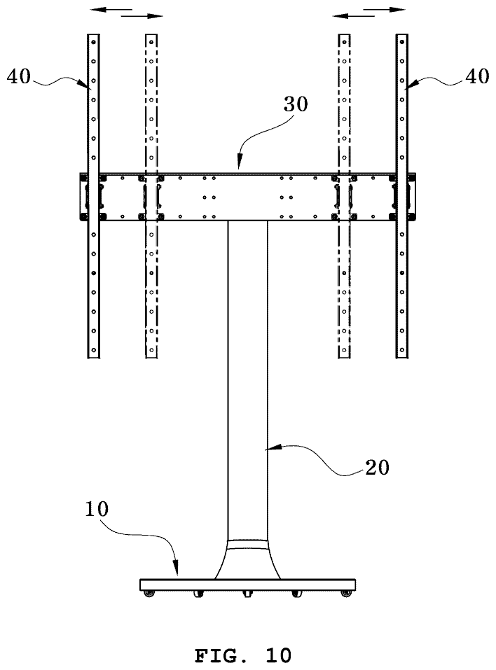

The stand for holding large displays configured as described above according to some aspects of the disclosure is used by appropriately adjusting the distance between both display mounts 40 through the position adjustment of the connection bracket 50, as illustrated in FIG. 10.

In addition, once the display is installed on the display mounts 40 to be supported by the base plate 10, the post 20, and the horizontal frame 30 through the connection brackets 50, the installation angle of the display mounts 40 is appropriately adjusted using the angle adjusting units 52 of the connection brackets 50.

As described above, according to some aspects, it is possible to install, on the stand, various VESA-standard displays including large displays by assembling the display mount assembled with the mount fixing unit onto the back side of the display, and then fitting the mount fixing units into the angle adjusting units of the connection brackets assembled with the horizontal frame in accordance with the width of the display mount.

In addition, since the installation angle of the display mount can be adjusted using the angle adjusting units of the connection brackets, it is possible to adjust the installation angle of the display as needed.

In addition, since a plurality of first and second mounting holes are formed at predetermined intervals along the length of the display mount, it is possible to properly adjust the position to be coupled to the VESA hole on the back side of the display, thereby adjusting the installation height of the display.

The above description has been illustrated by means of drawings showing preferred embodiments and assigning drawing symbols and designations to the configurations shown in the drawings for ease of explanation, but this is only one embodiment of the invention and should not be construed as limiting the scope of the claims to the shapes shown in the drawings and the designations assigned thereto, and it goes without saying that, from the description, the change of the present disclosure to various predictable shapes and the simple substitution of the present disclosure to a configuration having the same function are within a range that may be changed to easily implement the present disclosure by a person skilled in the art.

1. A stand for holding large displays, wherein the stand is configured to securely install a display, and comprises:
a base plate (10) of a predetermined size seated on a floor;
a post (20) of a predetermined length having a lower end assembled to the base plate (10) and installed vertically or inclined at a predetermined angle so that an upper end has a predetermined height;
a horizontal frame (30) installed at the upper end of the post (20) and horizontally installed so that both ends have a predetermined length on both sides of the post (20);
a pair of display mounts (40) assembled to a back side of a display and having a predetermined length in upward and downward directions based on the display; and
a pair of connection frames (50) configured to detachably connect the horizontal frame (30) and the pair of display mounts (40) and selectively adjustable in their angle to adjust the angle of the pair of display mounts (40), wherein
the pair of connection frames (50) include:
a frame fixing unit (51) installed on the horizontal frame (30);
an angle adjusting unit (52) installed on the frame fixing unit (51) in an angle-adjustable manner; and
a mount fixing unit (53) installed on the pair of display mounts (40) and detachably assembled to the angle adjusting unit (52).

2. The stand for holding large displays according to claim 1, wherein the horizontal frame (30) includes:
a horizontal portion (31) of a predetermined length covering an upper surface of the post (20); and
a vertical portion (32) of a predetermined length installed such that one end is connected to the horizontal portion (31) and the other end has a predetermined width and length along an upper side of one side of the post (20),
the vertical portion (32) includes a plurality of installation holes (32A) in which the frame fixing unit (51) is installed, and
the plurality of installation holes (32A) are disposed at predetermined intervals in a plurality of rows along a length of the vertical portion (32).

3. The stand for holding large displays according to claim 1, wherein a plurality of wheels are movably installed on a lower surface of the base plate (10).

4. The stand for holding large displays according to claim 1, wherein
the display mount (40) includes:
a frame portion (41) having a C-shaped cross-section and a length in a vertical direction;
first mounting holes (42) formed at predetermined intervals along a length on both sides of the frame portion (41) that are opposite to each other; and
a plurality of second mounting holes (43) formed at predetermined intervals along a length of one side of the frame portion (41) that is opposite to the back side of the display, and
the mount fixing unit (53) is installed through the first mounting holes (42), and the display mount (40) is engaged and fixed to the back side of the display by a screw through the second mounting holes (43).
